(19) United States
(12) Patent Application Publication
(10) Pub. No.: US 2003/0126162 A1
(43) Pub. Date: Jul. 3, 2003

(54) System and method for synchronizing databases in a secure network environment

(76) Inventors: Thomas Patrick Yohe, Dayton, OH (US); Scott Hertzog, Round Rock, TX (US); Brian C. Morris, Austin, TX (US)

Correspondence Address: A PATENT LAWYER CORP, PC, R WILLIAM GRAHAM, 22 S ST CLAIR ST, DAYTON, OH, 45402, US

(21) Appl. No.: 10/039,385

(22) Filed: Jan. 3, 2002

(51) Int. Cl. G06F 12/00

(52) U.S. Cl. 707/201; 709/211

(57) ABSTRACT

A method is provided for synchronizing databases among a server computer having a master database therein, and a client computer in communication with the server computer, wherein the client computer having a replica database of the master database therein, which comprises the steps of establishing communication between a server computer having a master database therein and a client computer, recognizing a replication request by the client computer for a piece of data within the master database from the server computer, initiating a registration authorization process of the client computer wherein the client computer is provided with software for accessing multicast updates of the data, and accessing a multicast of updated data using the accessing software. A system for carrying out the method is also provided.

### FIELD OF THE INVENTION

This invention relates to a system and method for updating databases and more particularly to a system and method for synchronizing a plurality of databases in a secure network environment. The invention efficiently delivers one way updates from a central database to client replicas of the database by multicasting each update only once.

### BACKGROUND OF THE INVENTION

There exist several current techniques for database replication for client computers connecting to a server over a communication network to increase the availability and reliability of information and the speed at which information is accessed. The server computer commonly employs a so-called “master” database, wherein changes, updates, and record deletions are made, whereas the client computers include databases referred to as “replica” databases.

It is an object to insure that any changes made to the master database are also incorporated within the replica databases and this process is known as “database synchronization” wherein the replica database is updated to reflect the current revision of the master database. Some database synchronization techniques rely on two-way communication between a computer containing the master database and a computer containing a replica database. One method for such computers containing replica databases is to initiate a conversation with the computer containing the master database and request that all updates and changes made since the last conversation be transmitted which is known as a “Request” from the client computer.

Usually, the master database record changed is “time-stamped” with the date and time of the update. A comparison is made between the time-stamp for each updated or changed record in the master database and the time-stamp information of the requesting replica database. Those records having a time-stamp later than the time-stamp of the requesting database, or later than the last conversation, will be transmitted. In addition to problems wherein the clocks of the computer containing the master database and the computer containing the replica database are not synchronized, the Requests made on a server computer can be burdensome and if a series of requests are made at common times the bandwidth requirements are significantly increased.

Alternative methods which involves locking the master database and transmitting updates to each replica at the same time are deficient in that no changes can be made to the master database during this time period. Obvious drawbacks include, locking of the master database to prevent changes, no changes or updates can occur during the multicast to the remote locations and the master database is unavailable for use, and if a client is not available for receiving the update the master database must be locked again to perform the update.

Multicasting is another synchronization method which involves transmitting the entire master database at predetermined intervals. This method is typically used in computer systems linked by receive-only communications, such as one-way satellite transmission systems. Drawbacks reside here in that there is no guarantee that the client computer will be connected in communication when the multicast takes place. Transmitting the entire database many times will not assure proper replication and it is a drain on the server computer and may require locking the master database during transmission.

Still another technique is to maintain the multicast number in the client computer and update the replica database only if the next received multicast is in numerical sequence. The problem with this method is that it still requires user intervention if the client computer misses several multicasts.

Although a multicasting support exists in most networks today, few applications take advantage of it. Under current technologies, updates are sent individually to clients resulting in tremendously increased network traffic and server load. Consequently, there remains a great need to improve the way databases are updated.

### DEFINTIONS

“Unicast” refers to a packet of data sent between a single sender and a single receiver on a network.

“Multicasting” refers to a packet of data sent to a specific group of end stations on a network.

“Multication” refers to a replication process performed by way of multicasting.

“Reliable Transmission” refers to guaranteed and acknowledged communication connection between a server computer and a client computer.

“Replication” is the process of exchanging modifications between replicas of a collection of objects.

“Unreliable Transmission” refers to a non-guaranteed and unacknowledged communication between a server computer and a client computer.

### SUMMARY OF THE INVENTION

It is an object of the invention to provide an improved system and method for synchronizing databases in a network environment wherein there is a communication link established between the server and client.

It is another object of the invention to provide a method and system for synchronizing databases employing a multicasting approach.

It is yet another object to reduce bandwidth requirements for distributing shared databases frequently updated by subscribing users.

It is still another object to reduce network traffic and server load when attempting to keep client replicas in sync with master databases.

Further, it is an object to transmit a single update (via multicast) regardless of the number of clients which may be able to obtain the update at the transmitted time. The present invention uses a multicasting approach to solve the synchronization problem in a particular replication environment, such as with Lotus Domino® servers, wherein master databases are kept in sync with a client computer, such as a Lotus Notes® client, to greatly reduce network traffic as a result.

Accordingly, the present invention is directed to a system for synchronizing databases among a server computer having a master database therein, and a client computer in communication with the server computer, wherein the client computer having a replica database of the master database therein. The system includes a server computer having hardware and software for storing a master database therein and a client computer having hardware and software for storing a replica of the master database. A communication link is provided connecting the server computer to the client computer. Software is provided for recognizing a replication request by the client computer for a piece of data within the master database of the server computer as well as software for initiating a registration authorization process of the client computer and providing the client computer with information data for accessing multicast updates of the data. The client has software for accessing a multicast of updated data using the accessing means.

In a preferred embodiment, the server computer is capable of multicasting a number of databases to a number of client computers which are connected to the server computer. The client computers can be remote or local and connected over fast or slow links.

The server computer includes software which is able to assemble packets of data into groups of packets referred to herein as “chains.” Each data packet has a packet sequence number. Each first in chain has an encryption key sequence which indicates to the client the validity of the client's encryption key.

Software, preferably residing on the client, detects when any packet is lost, and the software drops all subsequent packets in the chain until a packet indicating a new chain is detected where the packets are received for that chain. The lost packets in the prior chain can be picked up in a subsequent replication. Further, the software on the server computer can delay the transmission rate of data packets in order to permit the client computer to receive the data packets in a manner which it can handle.

The present invention further provides a method for synchronizing databases which utilizes the system described herein. The present invention thus eliminates the need for repeated multicasts of each of the changes in the database to the client computers. In addition, no acknowledgements either positive or negative are sent, thus reducing data traffic to the server as well as the need for complicated error recovery logic at the client and the server. Also, the amount of requests for updated information is reduced greatly by the present system.

### BRIEF DESCRIPTION OF THE DRAWINGS

FIG. 1 illustrates a schematic of a current state of art for database replication.

FIG. 2 illustrates a schematic of the present invention.

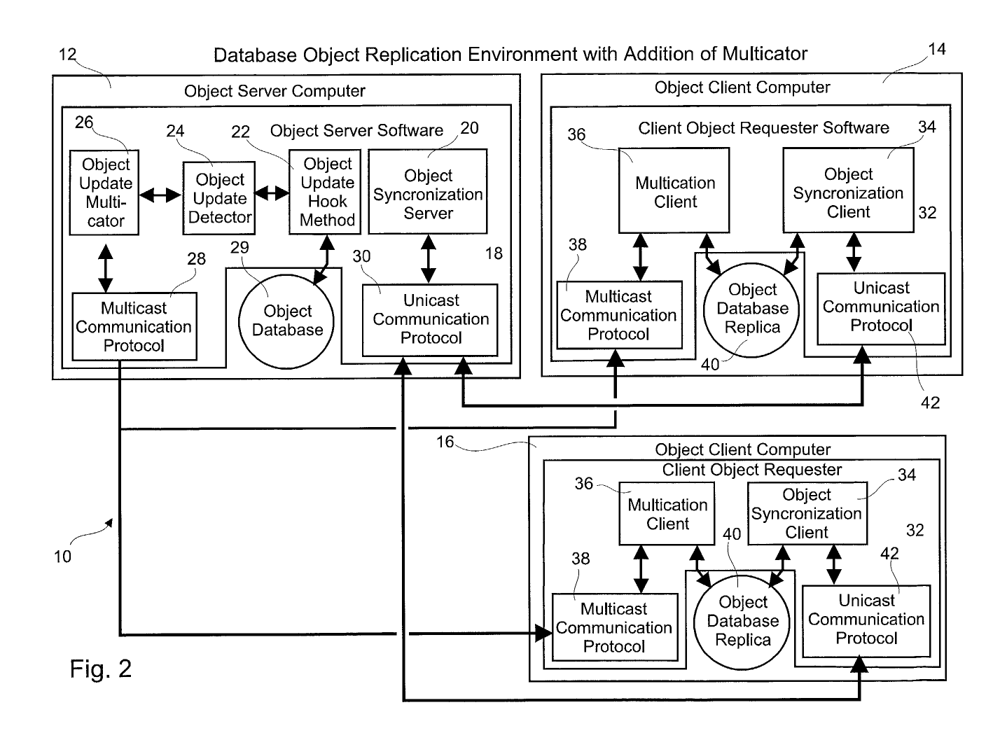

FIG. 3 illustrates a flow chart for the present invention.

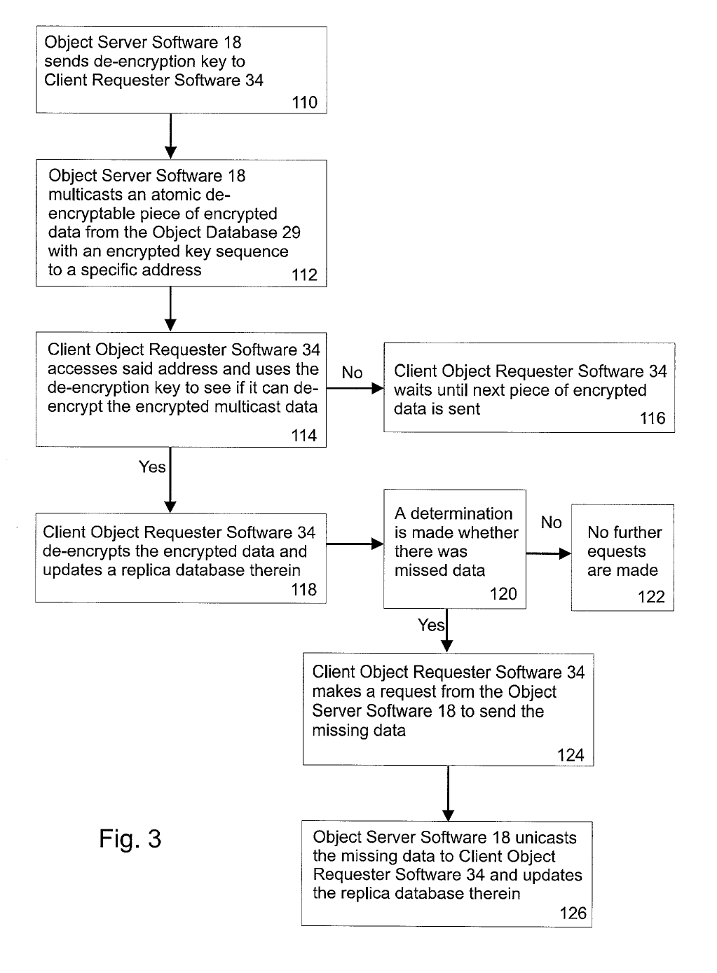

### DETAILED DESCRIPTION OF PREFERRED EMBODIMENTS

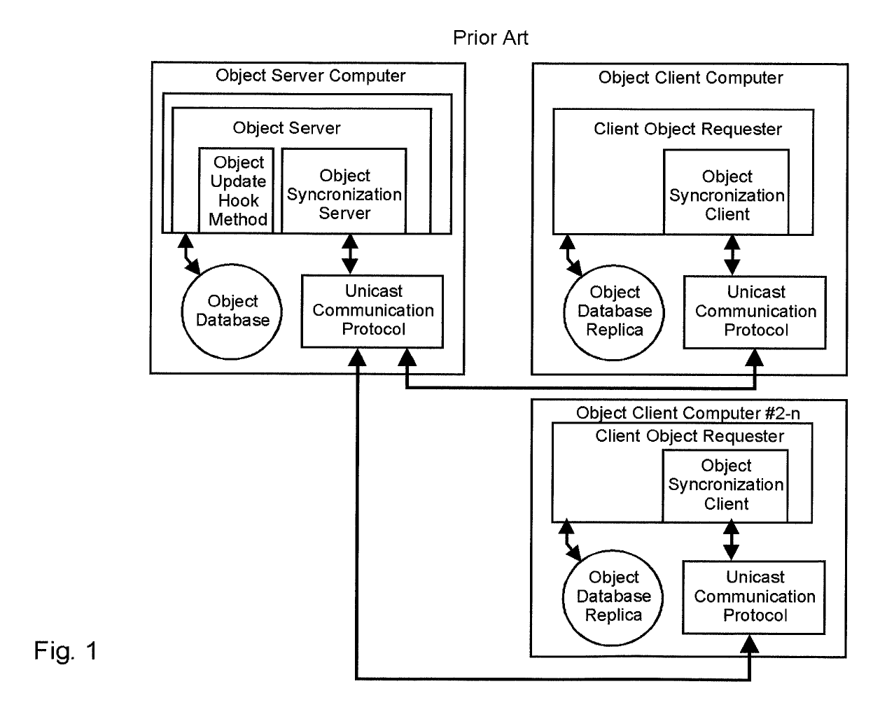

Prior hereto, multicasting was an efficient way for a single computer to send data to multiple other computers simultaneously, however, no guarantee that a reliable transmission exists such that the data would be received by client computers. Multicasting was not thought to provide a reliable solution to updating data. FIG. 1 represents a typical modality of the prior art. Therein, updated data can be sent using a unicast communication protocol. This provided a transmission of the updated data to each client, i.e., a packet of data was sent between a single sender and a single receiver in a reliable transmission over a network.

The present invention is a departure from this scheme in that the present invention uses a multicasting approach designated by the numeral 10 and described more fully hereinafter with reference to the accompanying drawings, in which the preferred embodiment of the invention is shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

More particularly, a system 10 and method for synchronizing databases in a secure network environment according to the present invention is shown. The system 10 includes, an object server computer 12 and a plurality of object client computers 14 and 16 which can be locally or remotely located and communicating with over a network via a communication link, for example, and in communication with the object server computer 12.

It is important to note that once communication is established between the object server computer 12 and object client computers 14 and 16, there is an acknowledgement of the presence of the object client computer 14 and 16 replication request of an object database 29. This can be done through a registration process described hereinafter.

The object server computer 12 includes, but is not limited to, an operating system, a first memory, a permanent storage memory, a processor, and a power source which are not shown for purposes of simplifying the drawings, but are understood to exist. The object server computer 12 has an object server software 18 including an object synchronization server 20, an object update hook 22, an object update detector 24, an object update multicator 26, a multicast communication protocol 28 and a unicast communication protocol 30, all of which are operably associated as described herein. Further, an object database 29 is provided which serves as the master database.

Each client computer 14 and 16 also includes, but is not limited to, an operating system, a first memory, a permanent storage memory, a processor and power source which are likewise not shown for purposes of simplifying the drawings, but are understood to exist. The object client computers 14 and 16 have client object requester software 32 including, an object synchronization client 34, a multication client 36, a multicast communication protocol 38 and a unicast communication protocol 42, all of which are operably associated as described herein. Further, provided is an object database replica 40 which serves as a replica database.

In the description which follows, the representation of the present invention is in part presented in terms of program operations executed on an object oriented distributed network of computers, but may as well be applicable to other file/object oriented network systems. The operations are steps leading to a certain result. Typically, these steps take the form of electrical signals which are manipulated, stored, transmitted, combined, compared or otherwise operated upon by a particular computer in the network. For simplicity, these signals may be referred to herein as bits, bytes or data.

The present invention describes solutions to the problems associated with a database synchronization, particularly, between a server and client computer's ability to synchronize data in an efficient manner thus minimizing the bandwidth necessary to operate the system.

The performance gains realized by the present invention are derived from the fact that object client computers 14 and 16 (e.g., remote clients) tend to repetitively access the same data in the object database 29 by performing file reads or object retrievals. The object server computer 12 provides an improved mechanism for database updates to the object client computers 14 and 16, and will improve performance significantly.

Using the present invention, a significant amount of updates are accomplished using the multicast communication protocol 28 and 38. The object server software 18 feeds the object client computers 14 and 16 missed information through unicast communication protocol 30. Under the present system, the object client computers 14 and 16 will be updated with new updated database information with minimal need for requests on the object server computer 12 for an updated database outside of the multicast communication protocol 28 and 38. Thus, the bandwidth requirement can be reduced.

The present invention enables the use of multicasting to achieve a reliable replication process at a greatly reduced cost to the user. By using the object server software 18 and client object requester software 32, there is provided a way to detect and recover lost packets of data.

An example of this would be as follows. Replications of the master database 29 is scheduled at predetermined times by the object server software 18 wherein the updated data is sent to a particular address having a sequenced encryption key therein via multicasting. If some data (i.e., data packets) is dropped by the network during the multicasting process, then the client object requester software 32 would pick up the missed data through unicast replication for any client computer that did not receive the missed data.

It is important to note that just because some computers may not have received a particular data packet or packets it is likely that some did receive these packets. This means that unless all client computers have missed a given data packet or chain of packets, data delivery will still be more efficient with the present invention. Thus, assuming a network's multicast packet loss should be minimal, the present invention provides a solution which is enormously efficient.

For example, a network with one hundred (100) client computers and a minimal packet loss would potentially only require approximately 1/100 of the data packet traffic for each multicated database. The network savings is potentially very large.

The present invention's allows concurrent multicasting of multiple databases from a single object server computer 12 with a verification process. The present invention accomplishes this via a registration procedure, having security and encryption supported therewith.

Registration Setup

The coordination of various database updates being received by the correct client, for example, object client computer 14 vs. client computer 16, is centrally controlled by the object server computer 12, particularly, the object update multicator 26 which can be referred to as a multicasting verifier.

The object update multicator 26 preferably has a range of addresses it will allocate to object client computers 14 and 16, for example, for multicasting of database updates. The object client computers 14 and 16 must subscribe to a particular database within the object database 29 to receive multicast data. The client object requestor software 32 of the present invention is equipped to dynamically learn which database(s) are being replicated from the object database 29 and will subscribe to the object server software 18 for each database. Thus, when an object client computer 14 first replicates a database the client object requestor software 32 via multication client 36 detects this and initiates a subscription registration request with the target object server software 18. This subscription registration request is treated essentially the same as a database open request in that a secure transmission session is set up with the target object server computer 12 using an authenticated session.

Once an authenticated session is established an “open subscription request” is sent from the object client computer 14, for example, to the connected object server computer 12. The open subscription request indicates which database the object client computer 14 would like to subscribe to for updates.

The object server computer 12 determines whether it is currently multicasting updates for the requested database. If yes, the object server computer 12 will return a multicast address the object server computer 12 is using for that database to the object client computer 14 via the unicast communication protocol 30 and 42. If no, and configured to do so, the object server computer 12 will allocate one of its multicast addresses, start a multicasting thread, register with the object update multicator 28 for updates and then return the multicast address as well as the encryption key required to de-encrypt data to the object client computer 14.

Upon receipt of the multicast address from the object server computer 12, the object client computer 14 will register with the communication protocol stack (e.g., TCP) to receive data packets for that address and start a receive multicast thread for that address. Once this is done, multicast packets can be received and upon arrival they are decompressed and routed to the appropriate database with the object database replica 40. The authenticated session used for subscription open requests will then be disconnected.

The client object requestor software 32 enables registration to receive multicast data packets to a particular address as well as the ability to specify source address when receiving multicasts in the future.

It is contemplated that it is possible for the object server computer 12 to be using the same multicast address for sending updates from the object database 29 as another object server computer sending from another object database

A problem with this is that the object client computer 14 may receive multicasts that are not intended for it. The client object requester software 32 verifies that the source address of the multicast is the same as the object server computer 12 to which it subscribes for the particular database.

Another problem is that multicast data packets may be propagated to network segments only to be thrown away by the object client computer 14. This is obviously a waste of network bandwidth. Accordingly, the object server software 18 solves this by using a range of multicast addresses to handle current network capabilities. As network capabilities increase, the object server software 18 will provide client object requester software 32 the source address feature of multicast registration.

Multicast Data Transfer

The object update multicator 26 multicasts object database 29 updates in a contiguous stream of multicast data packets through a multicast communication protocol 28. Each data packet contains a sequence number indicating uniqueness.

While each update is atomic, meaning that the update is a complete updateable piece of the database, the update may require multiple network data packets (i.e., multicasts) to be moved from the object server computer 12 to the object client computer 14. The grouping of these data packets form an individual update which is implemented by a chaining protocol, between the multicast communication protocol 28 and 38.

The chaining protocol consists of an indicator in each data packet which designates, for example, “First in Chain,” “Middle in Chain” or “Last in Chain.” Update lengths are not restricted; they can span as many packets as necessary. Small updates contained in single packets will be sent as Only in Chain.

The combination of the sequence numbers and the chaining protocol ensure that the client object requester software 32 can recognize when packets are lost. The object client computer 14 can join the multicast stream at the beginning of any chain. If any packet is lost, the object client computer 14 will drop all already received data packets in the current chain and continue to drop data packets until the beginning of the next chain. Initially, each chain will only contain a single database update, so if a packet is lost a single update is lost and will be recovered by the object requester software 32 at the next replication.

Object server software 18 can optionally optimize the data transfer by bundling multiple updates within a single chain. This will achieve better compression and streaming at the risk of having to drop more packets during data packet loss situations to resync to the next chain. It is contemplated, however, that this in turn could cause more work for the object client computer 14 in terms of number of lost updates. Accordingly, the object update multicator 26 is equipped with means to determine the number of updates to bundle and dynamically adjust the same based on error rates. These rates could be reported periodically by the object client computer 14 and the object update multicator 26 can set the bundle size to increase or decrease as needed. The object update multicator 26 remains static in this regard for a single update per chain. The present invention is also equipped to coordinate with replicators for database update loss recovery, which use techniques such as those employed by Lotus Notes®.

Hooking of Database Updates

Database updates are observed by the object update detector 24 for each subscribed database within the Object database 29 during an update process. A notification is sent to the object server software 18 via an internal interprocess communication. The object server software 18 will then read the update, compress the update, encrypt it, and multicast the update via the object update multicator 26 to the object client computer 14.

Encryption

Encryption of multicast data is performed by the object server software 18 on a per subscription basis. All object client computers 14 and 16 subscribed to a particular database within the object database 29 will receive the same encrypted data updates. This data will be de-encrypted using the negotiated keys at subscription start as earlier described. As mentioned, an encryption key sequence will be transmitted in each data packet. The client object requester software 32 will verify that it is using the current encryption key for that session. The object server software 18 permits change of the key at any time, but preferably will change the key at infrequent predetermined times. When the key changes, the object client computers 14 and 16 will need to re-subscribe and retrieve a new encryption key. Each chain comprises an atomic decryptable piece of data such that you cannot de-encrypt the same in receiving only part thereof. The reason is that one can join the multicast and access at various predetermined points, i.e., chains, and receive meaningful data at any first (beginning) in chain. Each chain can be processed independently of others.

Dataflow Control & Error Recovery

During the data transfer phase several techniques are used to minimize data packet loss by the client object software 32. Many factors can cause data loss including network failure and congestion, router overload as well as the inability of object client computers 14 and 16 to keep up with the transfer rate of the object server computer 12. It is difficult to predict or directly control the congestion or router overload issues. Thus, the present invention indirectly affects these conditions by providing within the object server software 18 means for throttling the transmission rate of the object server computer 18 during data transmission. This also will directly affect data packet loss due to object client computer 14 and 16 sluggishness.

It is contemplated both the object server computer 12 and the object client computer 14 and 16 participate in the throttling mechanisms. First, the object server software 18 has an internally defaulted (and configurable) inter-packet delay. This delay is enforced by object server software 18 between each data packet transmission. Secondly, an inter-chain delay is implemented to allow clients to digest a given update. Since a chain is a completed update or set of updates (in the case of bundling) the object server software 18 delays to allow the client object requester 32 to move the update from an in-memory cache structure to the physical disk. This delay is dynamically adjusted based on the size of the chain transmitted. Once a chain is completely transmitted, the object server software 18 computes a value for the delay and interposes this inter-chain delay.

The client object requester software 32 utilizes two threads per subscription, a receiving thread and a processing thread. The receive thread will receive the multicasts and put them into in-memory cache as they are received. The packets are de-encrypted by the receive thread and an object is then created and written without further data processing. The receive thread will notify the processing thread via an interprocess communication that an update is ready for processing. Chaining state machines and sequence numbers are checked by the processing thread to make sure these are valid updates. If so, the local replica is updated with the new data. If there are any problems with decryption, sequence numbers, or chaining states, the object is thrown away and the update is dropped. The client object requester software 32 will resync with the next chain of data.

Statistics

Statistics will be maintained at both the object server computer 12 via the object server software 18 and the object client computer 14 via the client object requester software 32.

Statistics and errors are reported to the object server software 18 from the object client requester software 32 during the unicast procedure. They are “piggy-backed” on the unicasted synchronization requests. The object server software 18 can use this information for dynamically tuning throttling mechanisms (how data is sent and by which mechanism) as well as general statistic reporting. Unicasting is only necessary if errors have happened and therefore may not occur for each object client computer 14 or 16. However, if many unicasts are happening for a particular client computer or groups of client computers this information is conveyed and can be processed by the server. Since these errors and statistics are reported via the unicast phase which is a reliable communication, it is an efficient way of error reporting. In some cases, multicasting could be quiesced, or minimized to reduce affect on network performance in high error cases.

Further, the client object requester software 32 is equipped to detect whether a predetermined large number of errors are occurring and if so it will attempt to re-subscribe with current error rate information. In the case where the number remains high, the client object requester software 32 can un-subscribe for a predetermined period.

The object server software 18 is equipped to require a multicast schedule to prevent unwanted multicast data during certain hours. Optionally, the server software 18 can tie mulitcasting to an encryption change to cause object client computers 14 and 16 to re-subscribe and thus make their presence known to the object server computer 12.

The invention teaches multicasting all of the database updates without regard to an ACL (Access Control List) and then allowing the client computer to enforce the application to the replica database based on its ACL. All of the information necessary for the client computer to enforce the ACL is exchanged during the unicast subscription registration phase. A piece of data is a single database update.

By way of example, the following packet formats define this client server protocol:

_{————} #define HAP_STARTSUBSCRIPTION_REQ_CMD 0x55
#define HAP_STOPSUBSCRIPTION_REQ_CMD 0x56
/*
* The following four packet formats:

| | |
|---|---|
| * | 1) OPEN SUBSCRIPTION REQUEST |
| * | 2) OPEN SUBSCRIPTION RESPONSE |
| * | 3) CLOSE SUBSCRIPTION REQUEST |
| * | 4) CLOSE SUBSCRIPTION RESPONSE |

* describe the data communications protocol of the subscription
* establishment (and teardown) phase. This protocol takes place
* over a urncast session.
*/
// OPEN SUBSCRIPTION REQUEST
//
_Packed struct hap_db_open_req{

| | | |
|---|---|---|
| BYTE | bFunctionCHSe; | // always 0x55 |
| BYTE | bResv; | |
| DWORD | dMessageLen; | |
| WORD | wSequenceValue; | // |
| DWORD | dConnectionHandle; | // as returned on startreq |
| DWORD | dReqCorrelator; | // set by sender |
| DWORD | dDbOpenAttributesMask; | |
| char | zFilePath | // null terminated file |
| | [HS_FILENAME_SIZE]; | name (must be last |
| | | structure item) |
| char | UserName | |
| | [HS_USERNAME_SIZE]; | |
| BYTE | zSignedNoteName[1]; | |
| WORD | wSignedNoteSize; | |
| BYTE | SignedNote[1]; | |
| WORD | wObjectPayUnCompLength; | // UnCompressed Length |
| | | of Payload |
| WORD | wCompressionAlgorithm; | // Compression |
| | | Algorithm |
| WORD | wAccessFlags; | // access rights of client |
| WORD | wAccessLevel; | // Priv of client |
| DWORD | dServerLatency; | |
| BYTE | sMd5Signature[ 16 ]; | // if packet signatures |
| | | required |

};
typedef_Packed struct hap_db_open_req HAP_DB_OPEN_REQ;
typedef_Packed struct hap_db_open_req *pHAP_DB_OPEN_REQ;
// OPEN SUBSCRIPTION RESPONSE
_Packed struct hap_db_open_subsciption_rsp{

| | | |
|---|---|---|
| BYTE | bFunctionCHSe; | // always 0xd5 |
| BYTE | bStatus; | |
| DWORD | dMessageLen; | |
| WORD | wSequenceValue; | // Same value as in |
| | | request |
| DWORD | dConnectionHandle; | // As returned on |
| | | HAP_START_{—} |
| | | CONNECT |
| DWORD | dReqCorrelator; | // returned by verifier |
| | | same as sent in |
| WORD | wDBOpenStatus; | |
| DWORD | dVerifiersDbHandle; | |
| struct | sockaddr_in | // address to use for this |
| | SubscriptionMulticastAddress; | subscription. |
| WORD | wOrigSocket; | // originating socket that |
| | | the verifier is |
| | | multicasting from |
| DWORD | dEncryptionSequence; | // sequence of current |
| | | encryption key |
| BYTE | bEncrypting; | // are we encrypting |
| DWORD | dSizeofGroupList; | // group list—used for |
| | | access control filtering at |
| | | the client |
| BYTE | bGroupList; | |
| BYTE | sMd5Signature[ 16 ]; | // if packet signatures |
| | | required |

};
typedef_Packed struct hap_db_open_subsciption_rsp

HAP_DB_OPEN_SUBSCRIPTION_RSP;

typedef_Packed struct_hap_db_open_subsciption_rsp

*pHAP_DB_OPEN_SUBSCRIPTION_RSP;

// CLOSE SUBSCRIPTION REQUEST
_Packed struct hap_db_close_req{

| | | |
|---|---|---|
| BYTE | bFunctionCHSe; | // always 0x56 |
| BYTE | bResv; | |
| DWORD | dMessageLen; | |
| WORD | wSequenceValue; | |
| DWORD | dConnectionHandle; | // As sent on |
| | | START_CONNECT |
| DWORD | dVerifiersFileHandle; | // As returned on |
| | | OPEN_OR_CREATE |

#define_HAP_DB_CLOSE_F_NORSP 1

| | | |
|---|---|---|
| WORD | wResponseFlags; | |
| BYTE | sMd5Signature[ 16 ]; | // if packet signatures |
| | | required |

};
typedef_Packed struct hap_db_close_req HAP_DB_CLOSE_REQ;
typedef_Packed struct hap_db_close_req *pHAP_DB_CLOSE_REQ;
// CLOSE DATABASE RESPONSE/CLOSE
SUBSCRIPTION REQUEST
_Packed struct hap_db_close_rsp{

| | | |
|---|---|---|
| BYTE | bFunctionCHSe; | // always 0xD6 |
| BYTE | bStatus; | // |
| DWORD | dMessageLen; | |
| WORD | wSequenceValue; | // Same value as in |
| | | request |
| DWORD | dConnectionHandle; | // As sent on |
| | | START_CONNECT |
| WORD | wDBCloseStatus; | |
| DWORD | dVerifiersFileHandle; | // As returned on |
| | | OPEN_OR_CREATE |
| BYTE | sMd5Signature[ 16 ]; | // if packet signatures |
| | | required |

};
typedef_Packed struct hap_db_close_rsp HAP_DB_CLOSE_RSP;
typedef_Packed struct hap_db_close_rsp *pHAP_DB_CLOSE_RSP;
/*
* Below is the format of the message blocks which are multicast from the
object server computer
* to the client computers which are subscribing to the database updates.
*/
_Packed struct hap_mcblockhdr{

| | | |
|---|---|---|
| WORD | wSignature; | // Length of response |
| | | block |
| WORD | wSequence; | // packet sequence |
| DWORD | dEncryptionSequence; | // sequence of current |
| | | encryption key |

| | | |
|---|---|---|
| #define HAPMC_F_FIC | 1 | // 0x01 = The first |

| | |
|---|---|
| (more to follow) | piece of an object |

| | | |
|---|---|---|
| #define HAPMC_F_MIC | 2 | // 0x02 = A middle |

| | |
|---|---|
| (more to follow) | piece of an object |

| | | |
|---|---|---|
| #define HAPMC_F_LIC | 4 | // 0x04 = The last piece |
| | | of an object |

| #define HAPMC_F_OIC (HAPMC_F_FIC | | | // 5 = Entire Object |
|---|---|---|---|
| \| HAPMC_F_LIC) | | | |
| #define HAPMC_F_{—} | | | // 0x10 = Change the |
| CHANGEENCRYPTIONKEY 10 | | | encryption key |
| | WORD | wFlags; | // figs, chaining, etc |
| | WORD | wCompAlg; | // Compression |
| | | | algorithm |

};

By way of example and referring to FIG. 4, the operation of the invention can take place as follows. Step 100—object server software 18 recognizes a replication request by client object requester software 34. If no, object server software 18 remains idle—step 102. If yes, then object server software 18 determines if object client computer 14/16 is on an access control list—step 104.

If yes, object server software 18 permits client object requester software 18 to replicate an authorized piece of data from the object database 29—step 106. If no, object server software 18 initiates registration authorization process with client object requester software 34 using a reliable communication link—step 108.

Object server software 18 sends a de-encryption key to client object requester software 34—step 110. Object server software 18 multicasts an atomic de-encryptable piece of encrypted data from the object database 29 with an encrypted key sequence to a specified addresses—step 112. Client object requester software 34 accesses said address and uses the de-encryption key to if it can de-encrypt the encrypted multicast data—step 114.

If no, client object requester software 34 waits until next piece of atomic de-encryptable piece of encrypted data is sent—step 116. If yes, the client object requester software 34 de-encrypts the encrypted data and updates a replica database therein—step 118.

A determination is made whether there was missed updated data—step 120. If no, no further requests are made—step 122. If yes, the client object requester software 34 makes a request from the object server software 18 to send the missed data—step 124. The object server software 18 unicasts the missed data to the client object requester software 34 and updates the replica database therein—step 126

Note: the object server software 18 unicasts the missed data to the client object requester software 34 who in turn updates the database therein. The unicast session is independent of the data which is multicasted and it does not have to be encrypted though it it recognized herein that it can be encrypted.

In the drawings and specification, there have been disclosed typical preferred embodiments of the invention and, although specific terms are employed, they are used in a generic and descriptive sense only and not for purposes of limitation, the scope of the invention being set forth in the following claims. Modifications, derivations and improvements thereof shall be deemed as within the scope of the claims hereto.

That which is claimed:

1. A method for synchronizing databases among a server computer having a master database therein, and a client computer in communication with the server computer, wherein the client computer having a replica database of the master database therein, comprising the steps of:
establishing communication between a server computer having a master database therein and a client computer;
recognizing a replication request by said client computer for a piece of data within said master database from said server computer;
initiating a registration authorization process of said client computer wherein said client computer is provided with means for accessing multicast updates of said data; and
accessing a multicast of updated data using said accessing means.

2. The method of claim 1, which is further includes the steps of determining a missed multicast of updated data by said client computer and initiating a unicast of said missed updated data.

3. The method of claim 1, which is further characterized as:
establishing a connection between said server computer and a plurality of client computers;
recognizing a replication request by each said client computer for a piece of data within said master database from said server computer;
initiating a registration authorization process of said client computers wherein said client computers are provided with means for accessing multicast updates of said data; and
accessing a multicast of updated data using said accessing means.

4. The method of claim 3, wherein said step of recognizing replication requests are for different data for each said client computer, and said registration authorization process includes providing one of identical and unique means for accessing multicast updated data.

5. The method of claim 1, which further includes the step of determining whether to receive said update of said data.

6. The method of claim 5, wherein the step of determining is accomplished by maintaining in said client computer information relating to prior updates of said data by said client computer.

7. The method of claim 5, wherein the step of determining is accomplished by maintaining in said server computer information relating prior updates of said data by said client computer.

8. The method of claim 1, which further includes the step of determining the rate at which to multicast said data between said server computer and said client computer.

9. A system for synchronizing databases among a server computer having a master database therein, and a client computer in communication with the server computer, wherein the client computer having a replica database of the master database therein, comprising:
a server computer having means for storing a master database therein;
a client computer having means for storing a replica of said master database;
means for communicably connecting said server computer to said client computer;
means for recognizing a replication request by said client computer for a piece of data within said master database of said server computer;
means for initiating a registration authorization process of said client computer and providing said client computer with means for accessing multicast updates of said data; and
means for accessing a multicast of updated data using said accessing means.

10. The system of claim 9, which further includes means for determining a missed multicast of prior update of said data by said client computer and means for initiating a unicast of said missed prior update of said data.

11. The system of claim 9, which is further characterized to include:
a plurality of said client computers;
means for establishing a connection between said server computer and said plurality of client computers;
means for recognizing a replication request by each said client computer for a piece of data within said master database from said server computer; and
means for initiating a registration authorization process of said client computers wherein said client computers are provided with means for accessing multicast updates of said data; and
means for accessing a multicast of updated data using said accessing means.

12. The system of claim 11, wherein said datas are different for each said client computer, and said means for accessing multicast updates of each said different data are different for each client computer.

13. The system of claim 9, which further includes means for determining whether to receive said update of said data.

14. The system of claim 13, wherein said determining means is accomplished by maintaining in said client computer information relating to prior updates of said data by said client computer.

15. The system of claim 13, wherein said determining means is accomplished by maintaining in said server computer information relating prior updates of said data by said client computer.

16. The system of claim 9, wherein said file server computer has an operating system, a first memory, a permanent storage memory and a processor an object server software which includes an object synchronization server, an object update hook, an object update detector, an object update multicator, a multicast communication protocol, and a unicast communication protocol and an object database, and said client computer has an operating system, a first memory and a processor, an object client computer has a client object requester software which includes an object synchronization client and a multication client, a multicast communication protocol, and a unicast communication protocol, and an object database replica.

17. The system of claim 16, wherein said object server software includes means for encrypting said data and transmitting an encryption key sequence with said data and said client object requester software 32 will include said accessing means which includes means for verifying said encryption key and de-encrypting said data.

18. The system of claim 9, wherein said client computer is further characterized to be a server computer.

19. The system of claim 9, which further includes means for determining the rate at which to multicast said data.
